(19) United States
(12) Patent Application Publication
(10) Pub. No.: US 2024/0270655 A1
(43) Pub. Date: Aug. 15, 2024

(54) CONTROLLED RELEASE GLASS FERTILIZER AND A METHOD FOR PREPARING THE SAME

(71) Applicant: YILDIZ TEKNIK UNIVERSITESI, Istanbul (TR)

(72) Inventors: Miray CELIKBILEK ERSUNDU, Istanbul (TR); Ali Ercin ERSUNDU, Istanbul (TR)

(73) Assignee: YILDIZ TEKNIK UNIVERSITESI, Istanbul (TR)

(21) Appl. No.: 18/568,306

(22) PCT Filed: Jun. 1, 2022
(86) PCT No.: PCT/TR2022/050517

§ 371 Date: Dec. 8, 2023

(30) Foreign Application Priority Data
Jun. 9, 2021 (TR) 2021/009501

(51) Int. Cl. C05B 17/00; C03B 19/10; C03C 3/062; C03C 3/17; C03C 3/21; C03C 12/00; C05G 5/10; C05G 5/40

(52) U.S. Cl. CPC C05B 17/00; C03B 19/1005; C03C 3/062; C03C 3/17; C03C 3/21; C03C 12/00; C05G 5/10; C05G 5/40

(57) ABSTRACT

A phosphate-based glass fertilizer and a method for producing the same are provided. The glass fertilizer and a glass blend from which the glass fertilizer is obtained, have a composition that includes P₂O₅ with a molar proportion within the range between 40% and 50%, K₂O with a molar proportion within the range between 8% and 17%, CaO with a molar proportion within the range between 15% and 25%, Al₂O₃ with a molar proportion within the range between 3% and 10%, and Na₂O with a molar proportion within the range between 8% and 17%, with respect to the combined total molar amount of components that constitute the composition.

### CROSS REFERENCE TO THE RELATED APPLICATIONS

This application is the national phase entry of International Application No. PCT/TR2022/050517, filed on Jun. 1, 2022, which is based upon and claims priority to Turkish Patent Application No. 2021/009501, filed on Jun. 9, 2021, the entire contents of which are incorporated herein by reference.

### TECHNICAL FIELD

The present invention relates to a phosphate-based glass fertilizer and a method for producing the same.

### BACKGROUND

Fertilizers that are used for increasing agricultural yield are basically divided into two groups: organic and chemical fertilizers. Among them; organic fertilizers that include vermi-compost, treatment sludge, and animal and plant wastes are generally used as soil promoters because of their low nutritional grade. On the other hand, fertilizers that are classified as chemical fertilizers such as diammonium phosphate, urea, NPK (nitrogen-phosphorus-potassium) are nowadays vastly used due to their high nutritional grade. Yet, although they have a rich nutritional grade, chemical fertilizers in the market start to be replaced with controlled release fertilizers due to their rapid dissolving behaviour that causes important environmental problems.

Chemical fertilizers that are widely used for increasing agricultural yield demonstrate a very rapid dissolving behaviour. As a result, nutritional grade of the chemical fertilizer is quickly washed-off from soil, and necessary nutritional elements cannot be taken into plant bodies in a sufficient extent. Due to this rapid dissolving behaviour, different chemical fertilizers are usually required to be applied to the soil in different periods throughout a plant growth process. In addition, depending to its type, the chemical fertilizer may cause salinity or acidity in the soil, resulting in deterioration of the soil structure, thereby reducing the agricultural productivity. Chemical fertilizers may further cause many other environmental problems including eutrophication, nitrate accumulation in water, and heavy metal accumulation in soil.

Controlled release fertilizers are developed for overcoming such issues that are related to chemical fertilizers. Commercially available controlled release fertilizers are equivalent to chemical fertilizers in terms of their nutritional grades; yet their outer layers include a sulphur- or polymer-based coating for decelerating the release. This measure enables an environmentally friendly and high-yield fertilization. 50% of sulphur-coated controlled release fertilizers fracture during transportation, resulting in a rapid release of nutritional elements. Most of polymer coatings are not biodegradable, therefore they can cause toxic effects in soil.

In brief, in aspects that are considered important in view of the present specification, behaviour of known fertilizers can be classified as follows:

### 1. Evaluation in Terms of Dissolving Rate

a. Chemical fertilizers that are known in the art dissolve rapidly and ⅓ of their nutritional elements rapidly wash-off from soil without being adsorbed by the plant.
b. Controlled release fertilizers that are known in the art provide nutritional elements release control over the coating on an outer layer of the fertilizer.
c. Known fertilizers that are prepared from phosphate-based glass blends generally have a dissolving duration of about 330 days, yet in a study it is disclosed that a 4-months dissolving behaviour is established (DOI 10.1007/s12633-016-9443-7).
d. Fertilizers that are prepared from silica-based glass blends are known to have a dissolving duration of 5-40 days.

### 2. Evaluation in Terms of Soil pH Value

a. Chemical fertilizers that are known in the art can cause acidity or alkalinity in the soil.
b. Regarding the controlled release fertilizers that are known in the art, in terms of pH value, no evaluation is encountered that is considered suitable to be introduced into the present specification.
c. Known fertilizers that are prepared from phosphate-based glass blends allow the maintenance of pH balance in soil.
d. Known fertilizers that are prepared from silica-based glass blends decrease the soil pH to a level around 5.5.

### 3. Evaluation in Terms of Biodegradability

a. Chemical fertilizers that are known in the art are non-biodegradable.
b. Coating materials used in controlled release fertilizers that are known in the art are usually non-biodegradable.
c. Known fertilizers that are prepared from phosphate-based glass blends are generally biodegradable.
d. Known fertilizers that are prepared from silica-based glass blends are generally biodegradable.

### 4. Evaluation in Terms of Nutritional Grade

a. With the chemical fertilizers that are known in the art, necessary nutritional elements can only be provided by application of numerous different chemical fertilizers in combination.
b. Regarding the controlled release fertilizers that are known in the art, in terms of nutritional grade, no specific disclosure is encountered that is considered suitable to be introduced into the present specification.
c. Known fertilizers that are prepared from phosphate-based glass blends generally include most of the necessary micro and macro nutritional elements.
d. Known fertilizers that are prepared from silica-based glass blends generally include most of the macro nutritional elements. Yet, only a single publication is encountered that makes reference to silica-based glass fertilizers containing micro nutritional elements.

### 5. Evaluation in Terms of Application of Respective Fertilizers

a. Chemical fertilizers that are known in the art can require multiple, repetitive application throughout the period from seeding to harvesting, in accordance with plant-specific requirements.
b. In terms of manner of application of controlled release fertilizers that are known in the art, no specific disclosure is encountered that is considered suitable to be introduced into the present specification.
c. Known fertilizers that are prepared from phosphate-based glass blends generally show a dissolving behaviour of up to 30 days. Therefore, depending to the dissolving rate, such fertilizers can be applied in multiple repetitions throughout the period from seeding to harvesting.

### 6. Evaluation in Terms of Environmental Impact

a. Chemical fertilizers that are known in the art are harmful to the environment and may cause toxic effects.
b. Coating materials used in controlled release fertilizers that are known in the art may cause toxic effect in soil.
c. Known fertilizers that are prepared from phosphate-based glass blends are generally environmentally friendly.
d. Known fertilizers that are prepared from silica-based glass blends are generally environmentally friendly.

In the light of the evaluations listed above; it is considered important to provide a fertilizer with a favourable controlled release behaviour, that is advantageous in view of the aspects that are taken into account within the context of the present invention; and to propose a method for preparation of the same.

### SUMMARY

Primary object of the present invention is to overcome the above-mentioned shortcomings of the prior art. The present invention provides a phosphate-based glass fertilizer that goes beyond the prior art in terms of dissolving rate, soil pH balance, biodegradability, nutritional grades, manner of application and environmental impact; and proposes a method for producing the same starting from a glass blend.

Said glass fertilizer and the glass blend that is prepared in the step i in the method for producing said fertilizer includes, with respect to the combined total molar amount of components that are included in the composition, P₂O₅ within the range between 40% and 50% mol/mol, K₂O within the range between 8% and 17% mol/mol, CaO within the range between 15% and 25% mol/mol, Al₂O₃ within the range between 3% and 10% mol/mol, and Na₂O within the range between 8% and 17% mol/mol.

The glass fertilizer and respective glass blend preferably includes polyphosphate in a molar proportion of 40%, or metaphosphate in a molar proportion of 50%, with respect to the combined total molar amount of components in the composition.

In the glass fertilizer and glass blend compositions, the molar amounts of K₂O and Na₂O are preferably equal to each other.

In a preferred implementation of the present invention, the glass fertilizer and glass blend include SiO₂ in a molar proportion of up to 10%, with respect to the combined total molar amount of components that are included in the composition.

In a preferred implementation of the present invention, the glass fertilizer and glass blend include one or more micro nutritional elements (micronutrients) selected from Mn, Mo, B, Fe, Cu and Zn. The glass fertilizer and glass blend preferably include one or more micro nutritional elements selected from MnO, MoO₃, B₂O₃, Fe₂O₃, CuO and ZnO, and more preferably the glass fertilizer and glass blend include all of said micronutrients. The glass fertilizer and glass blend preferably include one or more, more preferably all of the following components; provided that their combined molar amount does not exceed 6% of the combined total molar amount of materials that constitute the respective composition:

MnO with a molar proportion within the range between 0.1% and 1%, MoO₃ with a molar proportion within the range between 0.1% and 1%, B₂O₃ with a molar proportion within the range between 0.1% and 1%, Fe₂O₃ with a molar proportion within the range between 0.1% and 1%, CuO with a molar proportion within the range between 0.1% and 1% and ZnO with a molar proportion within the range between 0.1% and 1%.

The glass fertilizer and glass blend preferably include one or more of transition metals that are indicated in the periodic table of elements, provided that their combined molar amount does not exceed 1% of the combined total molar amount of materials in the composition. Said transition metals can preferably be one or more selected from Ni and Co.

The method for preparing the glass fertilizer according to the present invention includes: preparation of the glass blend, then in a step ii, melting the glass blend preferably at a temperature above 1000° C., more preferably at a temperature within the range between 1000° C. and 1300° C. After said melting step, the method according to the present invention includes a step iii directed to subjecting the molten glass blend to a rapid cooling to obtain pieces in the form of frit or granules.

After the step iii, the method preferably includes a milling process for obtaining particles with a mean particle size of up to 0.50 mm, more preferably within the range between 0.10 mm and 0.50 mm, even more preferably within the range between 0.25 mm and 0.50 mm.

### DETAILED DESCRIPTION OF THE EMBODIMENTS

Glass compositions can contain macronutrients (e.g., P, K, Ca and Mg) and micronutrients (e.g., Mn, Mo, B, Fe, Cu, Zn) that are necessary for the nutrition of a plant, and the dissolving behaviour can be controlled by varying the composition. With the controllable dissolving behaviour, glass fertilizers contribute to the nutrition of plants by releasing the nutrients they contain to the soil. The dissolving rate is variable in a wide range by introduction of an additional component into the glass composition, or by changing the ratios of the components in the composition structure. By this way it can be ensured that the macro- and micronutrients that are necessary for nutrition of plants are slowly released in a controlled manner. It is further possible to achieve desired dissolving rates under different/variable conditions, by tuning the compositions of glass fertilizers in accordance with plant, soil and climate characteristics. Glass is acknowledged as a 100% recyclable material and it does not release any toxic matter when introduced to soil. Accordingly, a glass fertilizer would provide an effective plant growth thanks to its tunable/controllable dissolving rate, rich nutrients content and environmentally friendly character.

Phosphate-based glasses have a potential to be used as a controlled-release fertilizer that increases agricultural yield, by being environmentally friendly, their ability to include macro- and micro nutrients in their compositions, and their broad-range dissolving rate tunability via composition control.

The phosphate-based glass fertilizer according to the present invention can contain macro- and micronutrients that are necessary for plant growth, in its composition; and its dissolving behaviour can be controlled throughout a broad range by modifications in the composition. The tunability of dissolving behaviour by modifying the composition provides an effective plant growth; furthermore, a sufficient extent of nutrients can be provided by applying to the soil even only once at the beginning of the seed-time, since the release of nutrients takes place throughout a prolonged duration. In addition, glass is a 100% recyclable material and does not release any toxic matter to the soil. Hence, glass fertilizers are completely environmental friendly, never causing any degradation in the soil structure. Additionally, the composition of the glass fertilizer according to the present invention enables the achievement of desired dissolving rates for various different conditions, by means of tuning its composition in accordance with plant, soil and climate-related characteristics.

The phosphate-based glass fertilizer according to the present invention includes a plurality of macronutrients, and preferably, further includes a plurality of micronutrients.

The present invention further proposes a method for production of said glass fertilizer. The method according to the present invention includes the following steps:
i. preparation of a glass blend, such that the glass blend comprises P₂O₅ within the range between 40% and 50% in molar percentage, K₂O within the range between 8% and 17% in molar percentage, CaO within the range between 15% and 25% in molar percentage, Al₂O₃ within the range between 3% and 10% in molar percentage, and Na₂O within the range between 8% and 17% in molar percentage, based on the combined total molar amount of components that constitute the composition of the glass blend;
ii. melting the glass blend that is prepared in the step i;
iii. subjecting the molten glass blend obtained in the step ii to a rapid cooling, for obtaining particles in the form of frit or granules.

Said glass blend is considered as a phosphate-based glass blend because of the amount of phosphate (P₂O₅) content in its composition. Therefore, the fertilizer that is obtained from said blend is a phosphate-based glass fertilizer. In the glass blend that is prepared in the step i of the method according to the present invention, and in the glass fertilizer composition obtained therefrom, the range of the P₂O₅ amount (that can be named as molar % concentration, or % concentration) is observed to be suitable for formation of a network structure within the glass fertilizer, that enables the dissolving rate to be optimized. Thanks to said amount range, phosphate is hereby acknowledged as a component that has an important role in prolonging the dissolving time to a desired extent, that is, in decreasing the dissolving rate to a desired extent.

P₂O₅ used in the step i of the method can be obtained from one or more of its compounds including orthophosphoric acid, ammonium dihydrogen orthophosphate, diammonium hydrogen orthophosphate, potassium dihydrogen orthophosphate, tri-calcium phosphate, aluminium orthophosphate, or mixtures thereof. Prior to the step i, the method can include a respective step of obtaining P₂O₅.

P₂O₅ used in the step i of the method can include, for instance, metaphosphate, polyphosphate or mixtures thereof. In a preferred implementation of the invention, in the cases where the phosphate content is close to the upper limit of the respective range, the phosphate content can substantially include metaphosphate. In another preferred implementation of the invention, in the cases where the phosphate content is close to the upper limit of the respective range, the phosphate content can substantially include polyphosphate. For instance, molar proportion of the polyphosphate content in the glass blend can be 40%. In another exemplary implementation, molar proportion of the metaphosphate content in the glass blend can be 50%.

In the case where the glass blend and the fertilizer obtained therefrom includes more than one alkali metal compounds (K₂O and Na₂O) in combination, and in particular, in the case where these are present in substantially equal molar amounts with regard to each other, said blend and the fertilizer obtained therefrom are considered to include “mixed alkali”. Thanks to the mixed alkali effect, the dissolving rate of such glass fertilizer is dramatically prolonged, in particular, in the case where the K₂O and Na₂O contents are substantially equal to each other. Accordingly, in a preferred implementation of the present invention, in the step i of the method and in the glass fertilizer composition, the molar amounts of sodium and potassium can be substantially equal to each other. Within this context, the step i of a preferred implementation of the method according to the present invention, can include preparation of the glass blend such that the molar percentage of K₂O and the molar percentage of Na₂O are equal to each other. Accordingly, the glass fertilizer obtained by a preferred implementation of the present invention can contain potassium and sodium with substantially equal molar proportions with regard to each other.

CaO used in the step i of the method can be obtained from any one of the following compounds: tri-calcium phosphate, calcium sulphate, calcium carbonate, gypsum, dolomite, calcium cyanamide, or from a mixture thereof. The method can include such step of obtention prior to the step i.

Alumina and mixed alkali contents and their respective amounts in the glass blend and in the fertilizer composition obtained therefrom, provides controlled release with dissolving times of much longer than 40 days.

It is observed that the alumina (Al₂O₃) in the glass blend increases the chemical resistance of the glass fertilizer, and lowers its dissolving rate. This fact is interpreted as that alumina causes cross-linking between phosphate chains. Yet, in the cases where the alumina molar content exceeds 10% of the combined total molar amount of materials constituting the glass blend, it is observed that the resulting glass fertilizer has a decreased chemical resistance and an increased dissolving rate.

The method according to the present invention and the glass fertilizer obtained as the resulting product of the method provides an advantageous dissolving behavior even in the case where the respective composition does not include SiO₂. SiO₂ relatively decreases the chemical resistance of the fertilizer in neutral media, but increases the chemical resistance when in acidic media. Hence, it is observed that in the case where SiO₂ has been introduced into the composition during preparation of the glass blend in the step i of the method, a prolonged dissolving time is observed in acidic medium that occurs in vicinity of plant roots. Within this context, preferably, at the step i of the method, the glass blend can be prepared such that it comprises SiO₂ in a molar amount of up to 10% with regard to the total amount of materials that constitutes the glass blend. The fertilizer that is obtained in accordance with this measure comprises SiO₂ in a molar amount of up to 10% with regard to the total amount of materials that constitutes the fertilizer. In the cases where the compositions of the glass blend of the fertilizer obtained therefrom includes SiO₂ within said range, controlled release related dissolving times of up to 90 days are observed. Such duration is considered sufficient for growth/herborization of any plant species. SiO₂ used in the step i of the method can be obtained from one or more selected from silica sand, feldspar, blast furnace slag components, or a mixture thereof. Prior to the step i the method can include such step for obtention.

The glass blend that is prepared at the step i of the method according to the present invention, and the glass fertilizer that is obtainable from such glass blend shows an advantageous dissolving behavior even in the case it does not include micronutrients. Yet, preferably, the glass blend that is prepared at the step i of the method according to the present invention, and the glass fertilizer that is obtainable from such glass blend can be prepared such that it contains one or more micronutrients. Examples to the micronutrients include Mn, Mo, B, Fe, Cu and Zn. In the step i of the method, the glass blend can be prepared such that it includes, for example, one or more selected from MnO, MoO₃, B₂O₃, Fe₂O₃, CuO and ZnO, or preferably, all of said compounds. In the step i, the glass blend can be preferably prepared such that it comprises micronutrients, provided that the combined total molar amount of the micronutrients does not exceed 6%, more preferably does not exceed 1%, of the combined total molar amount of components that constitute the glass blend. For instance, the glass blend can be preferably prepared such that it includes one or more, more preferably all of the following, provided that the combined total molar amount thereof does not exceed 6% with regard to the total amount of materials: MnO in a molar proportion within the range between 0.1% and 1%, MoO₃ in a molar proportion within the range between 0.1% and 1%, B₂O₃ in a molar proportion within the range between 0.1% and 1%, Fe₂O₃ in a molar proportion within the range between 0.1% and 10%, CuO in a molar proportion within the range between 0.10% and 10%, and ZnO in a molar proportion within the range between 0.1% and 1%. More preferably, the glass blend can be prepared such that it includes one or more, more preferably all of the following, provided that the combined total molar amount thereof is 1% with regard to the total amount of materials: MnO in a molar proportion within the range between 0.1% and 1%, MoO₃ in a molar proportion within the range between 0.1% and 1%, B₂O₃ in a molar proportion within the range between 0.1% and 1%, Fe₂O₃ in a molar proportion within the range between 0.1% and 1%, CuO in a molar proportion within the range between 0.1% and 1%, and ZnO in a molar proportion within the range between 0.1% and 10%.

In step i, the glass blend includes P, K and Ca amongst macronutrients. In a possible implementation of the method, one or more selected from N, Mg and S can be introduced when preparing the glass blend; the glass fertilizer that is prepared in accordance with this measure can also include one or more components selected from N, Mg and S as macronutrients.

K₂O that is used in the step i of the present method can be obtained from any of the compounds selected from potassium sulphate, potassium persulfate, potassium bisulphate, potassium carbonate, or mixtures thereof. The method can include a respective obtention step prior to the step i.

Al₂O₃ that is used in the step i of the present method can be obtained from any of the components selected from aluminium sulphate, aluminium orthophosphate, calcined alumina, hydrated alumina, feldspar, blast furnace slag, or mixtures thereof. The method can include a respective obtention step prior to the step i.

Na₂O that is used in the step i of the present method can be obtained from any of the components selected from sodium carbonate, sodium sulphate, sodium borate, sodium hydroxyde, sodium nitrate, or mixtures thereof. The method can include a respective obtention step prior to the step i.

In a preferred implementation of the present invention, the step i can be implemented such that the glass blend includes one or more of transition metals from the periodic table of elements (in other words, group-B elements or transition elements), for instance, nickel and/or cobalt. Accordingly, the resulting glass fertilizer can also preferably include said one or more transition metals (for instance, Ni and/or Co). It is preferred that the combined total molar amount of said transition metals does not exceed 1% of the total amount of materials that constitute the glass blend.

The melting process in the step ii of the method is preferably performed at a temperature within the range between 1000° C. and 1300° C.

The melting process in the step ii of the method can be performed in a melting pot that is resistant to temperatures of 1000° C. or higher. The material from which the melting pot is formed can be selected from, e.g., alumina or platinum.

The rapid cooling process in the step iii of the method can be performed by, e.g., pouring the glass blend that is molten in the step ii into a water bath that is at room temperature, or, passing said molten glass blend through water-cooled rolls. In the case where a water bath is used in the step iii of the method, granules are obtained; whereas, in the case where water-cooled rolls are used, pieces are obtained in the form of frit.

The method preferably includes subjecting the pieces that are obtained in the step iii, to a grinding process. Said grinding process can be performed, e.g., formation of bulk glass pieces by rapid cooling followed by grinding thereof. Said grinding process is preferably implemented such that the particles have a mean particle size of up to 0.50 mm, more preferably within the range between 0.10 mm and 0.50 mm, and even more preferably within the range between 0.25 mm and 0.50 mm. Said preferred mean particle sizes are, in accordance with their ranking in preferability, considered to be advantageous in view of contact surface between the resulting fertilizer particles and soil. Said mean marticle size can be D₅₀ particle size.

An important portion of chemical fertilizers are washed-off from the soil by irrigation water, and this results in loss of an important portion of nutrients. However, the glass fertilizer according to the present invention shows a slow dissolving behavior, thereby prevents the nutrient losses. The phosphate-based glass fertilizer according to the present invention is completely environmentally friendly, and has a structure that is suitable for containing the macro- and micronutrients that are necessary for the plants throughout the growth period. In addition, the fertilizer according to the present invention continuously releases the nutrients content throughout the plant growth period, thanks to the controlled dissolving behavior thereof. Accordingly, the phosphate-based glass fertilizer provides an effective growth nutrition/growth, thereby increasing the production yield and quality.

A comparative evaluation of the fertilizer according to the present invention with regard to prior art fertilizers can be summarized as follows:
1. The dissolving behavior of the phosphate-based glass fertilizer according to the present invention can be controlled via tuning of its composition, in accordance with a duration in which a respective plant necessitates to be nutritioned.
2. Soil pH balance can be maintained by using the phosphate-based glass fertilizer according to the present invention.
3. The phosphate-based glass fertilizer according to the present invention is biodegradable.
4. The phosphate-based glass fertilizer according to the present invention is suitable to contain a variety of necessary nutrients within a single glass fertilizer composition.
5. The fertilizer need throughout the growth process of a plant is a parameter that determines in which period a fertilizer is to be renewed and for how long is the fertilizer to be applied. The fertilizer according to the present invention has dissolving periods for up to 90 days, thus it can continue releasing throughout the growth periods of a very wide variety of plant species. Accordingly, it is sufficient that the phosphate-based glass fertilizer according to the present invention is applied once at the beginning of a plant seeding period.
6. With respect to environmental impact, the phosphate-based glass fertilizer according to the present invention is environmentally friendly and it does not release any toxic compound.

The phosphate-based glass fertilizer proposed within the context of the present invention has shown a successful controlled release behaviour by continuing release for periods of even longer than 90 days, even in neutral pH medium and in acidic pH medium that occurs due to secretion of citric acid from plant roots.

What is claimed is:

1. A phosphate-based glass fertilizer, comprising a composition, wherein the composition comprises components of P₂O₅ with a molar proportion within a range between 40% and 50%, K₂O with a molar proportion within a range between 8% and 17%, CaO with a molar proportion within a range between 15% and 25%, Al₂O₃ with a molar proportion within a range between 3% and 10%, and Na₂O with a molar proportion within a range between 8% and 17%, with respect to a combined total molar amount of the components.

2. The phosphate-based glass fertilizer according to claim 1, wherein the composition of the glass fertilizer comprises polyphosphate with a molar proportion of 40%, or metaphosphate with a molar proportion of 50%, with respect to the combined total molar amount of the components.

3. The phosphate-based glass fertilizer according to claim 1, wherein a molar amount of the K₂O and a molar amount of the Na₂O are equal to each other.

4. The phosphate-based glass fertilizer according to claim 1, wherein the phosphate-based glass fertilizer comprises SiO₂ with a molar proportion of up to 10%, with respect to the combined total molar amount of the components.

5. (canceled)

6. (canceled)

7. The phosphate-based glass fertilizer according to claim 1, comprising one or more of the following components at a combined molar amount not exceeding 6% of the combined total molar amount of the components:
MnO with a molar proportion within a range between 0.1% and 1%,
MoO₃ with a molar proportion within a range between 0.1% and 1%,
B₂O₃ with a molar proportion within a range between 0.1% and 1%,
Fe₂O₃ with a molar proportion within a range between 0.1% and 1%,
CuO with a molar proportion within a range between 0.1% and 1%, and
ZnO with a molar proportion within a range between 0.1% and 1%.

8. The phosphate-based glass fertilizer according to claim 1, comprising one or more of the following components at a combined molar amount not exceeding 1% of the combined total molar amount of the components:
MnO with a molar proportion within a range between 0.1% and 1%,
MoO₃ with a molar proportion within a range between 0.1% and 1%,
B₂O₃ with a molar proportion within a range between 0.1% and 1%,
Fe₂O₃ with a molar proportion within a range between 0.1% and 1%,
CuO with a molar proportion within a range between 0.1% and 1%, and
ZnO with a molar proportion within a range between 0.1% and 1%.

9. (canceled)

10. The phosphate-based glass fertilizer according to claim 1, comprising one or more of transition metals selected from the periodic table of elements, wherein the transition metals have a combined molar proportions not exceeding 1% of the combined total molar amount of the components.

11. The phosphate-based glass fertilizer according to claim 10, wherein the transition metals are at least one of Ni and Co.

12. The phosphate-based glass fertilizer according to claim 1, comprising particles with a mean particle size of up to 0.50 mm.

13. The phosphate-based glass fertilizer according to claim 12, wherein the mean particle size is within a range between 0.10 mm and 0.50 mm.

14. (canceled)

15. A method for a production of a phosphate-based glass fertilizer, comprising the following steps:
i. preparing a glass blend, wherein the glass blend comprises components of P₂O₅ with a molar proportion within a range between 40% and 50%, K₂O with a molar proportion within a range between 8% and 17%, CaO with a molar proportion within a range between 15% and 25%, Al₂O₃ with a molar proportion within a range between 3% and 10%, and Na₂O with a molar proportion within a range between 8% and 17%, based on a combined total molar amount of the components of the glass blend;
ii. melting the glass blend prepared in step i to obtain a molten glass blend;
iii. subjecting the molten glass blend obtained in step ii to a rapid cooling, for obtaining particles in a form of frit or granules.

16. The method according to claim 15, wherein in step i, the glass blend comprises polyphosphate with a molar proportion of 40% or metaphosphate with a molar proportion of 50%.

17. The method according to claim 15, wherein in step i, the glass blend comprises SiO₂ with a molar proportion of up to 10%.

18. The method according to claim 15, wherein in step i, the glass blend comprises the K₂O and the Na₂O at an equal molar amount.

19. (canceled)

20. (canceled)

21. The method according to claim 15, wherein in step i, the glass blend comprises one or more of the following components at a combined molar amount not exceeding 6% of the combined total molar amount of the components:
MnO with a molar proportion within a range between 0.1% and 1%,
MoO₃ with a molar proportion within a range between 0.1% and 1%,
B₂O₃ with a molar proportion within a range between 0.1% and 1%,
Fe₂O₃ with a molar proportion within a range between 0.1% and 1%,
CuO with a molar proportion within a range between 0.1% and 1%, and
ZnO with a molar proportion within a range between 0.1% and 1%.

22. The method according to claim 15, wherein in step i, the glass blend comprises one or more of the following components at a combined molar amount not exceeding 1% of the combined total molar amount of the components:
MnO with a molar proportion within a range between 0.1% and 1%,
MoO₃ with a molar proportion within a range between 0.1% and 1%,
B₂O₃ with a molar proportion within a range between 0.1% and 1%,
Fe₂O₃ with a molar proportion within a range between 0.1% and 1%,
CuO with a molar proportion within a range between 0.1% and 1%, and
ZnO with a molar proportion within a range between 0.1% and 1%.

23. (canceled)

24. The method according to claim 15, wherein in step i, the glass blend comprises one or more of transition metals selected from the periodic table of elements, and wherein the transition metals have a combined molar amount not exceeding 1% of the combined total molar amount of the components.

25. The method according to claim 24, wherein in step i, the glass blend comprises one or more transition metals selected from Ni and Co.

26. The method according to claim 15, wherein after step iii, a grinding process is further comprised to enable a mean particle size of the particles is up to 0.50 mm.

27. The method according to claim 26, wherein after step iii, a grinding process is further comprised to enable a mean particle size of the particles is within a range between 0.10 mm and 0.50 mm.

28. (canceled)
